(19) United States
(12) Patent Application Publication
(10) Pub. No.: US 2016/0293305 A1
(43) Pub. Date: Oct. 6, 2016

(54) SINTERED MAGNET PRODUCTION METHOD

(71) Applicant: INTERMETALLICS CO., LTD., Nakatsugawa-shi (JP)

(72) Inventors: Kazuyuki KOMURA, Kyoto-shi (JP); Masato SAGAWA, Kyoto-shi (JP)

(21) Appl. No.: 14/778,431

(22) PCT Filed: Mar. 10, 2014
(86) PCT No.: PCT/JP2014/056180

§ 371 Date: Sep. 18, 2015

(30) Foreign Application Priority Data
Mar. 25, 2013 (JP) 2013-061344

(51) Int. Cl. H01F 1/057; C22C 38/52; C22C 38/42; C22C 38/16; B22F 9/04; C22C 38/06; C22C 38/04; C22C 38/00; B22F 1/00; B22F 3/10; C22C 38/54; C22C 38/10

(52) U.S. Cl. CPC H01F 1/0577; C22C 38/54; C22C 38/52; C22C 38/42; C22C 38/16; C22C 38/10; C22C 38/06; C22C 38/04; C22C 38/005; C22C 38/002; B22F 1/0059; B22F 1/0014; B22F 3/1017; B22F 9/04; B22F 2009/045; B22F 2301/355; B22F 2303/01; B22F 2304/10; B22F 2304/058

(57) ABSTRACT

A sintered magnet production method includes filling the cavity of a container with an alloy powder of a raw material for a sintered magnet, orienting the alloy powder in the cavity by applying an magnetic field to the alloy powder without applying a mechanical pressure, and sintering the oriented alloy powder by heating the alloy powder without applying a mechanical pressure. The median D₅₀ of a particle size distribution of the alloy powder measured by a laser diffraction method is 3 μm or less, and a powder of a high-melting-point material having a higher melting point than the heating temperature in the sintering process is mixed in the alloy powder before or in the filling process. The median D₅₀ of the powder of the high-melting-point material is 0.3 μm or less.

### TECHNICAL FIELD

The present invention relates to a method for producing a sintered magnet containing a rare-earth element R, such as an RFeB (R₂Fe₁₄B) or RCo (RCo₅ or R₂Co₁₇) system sintered magnet.

### BACKGROUND ART

For the production of sintered magnets, a method has been conventionally used which includes the steps of filling the cavity of a mold with a fine powder of a starting alloy (“filling process”; this powder is hereinafter called the “alloy powder”), applying a magnetic field to the alloy powder in the cavity to orient the particles of the alloy powder (“orienting process”), subsequently applying pressure to the alloy powder to produce a compression-molded compact (“compression-molding process”), and heating the compression-molded compact to sinter it (“sintering process”). Another method has also been used in which, after the filling process, the orienting process and the compression-molding process are simultaneously performed by applying a magnetic field to the alloy powder while applying pressure with a pressing machine. In any of these cases, compression molding is performed with a pressing machine. Therefore, in the present application, these methods are called the “pressing method.”

Due to their high magnetic properties, RFeB system sintered magnets are expected to be increasingly in demand in the future as permanent magnets for motors used in hybrid cars and electric cars as well as for other applications. Automobiles must be designed for use under extreme loading conditions, and accordingly, their motors also need to be guaranteed to operate under high-temperature environments (e.g. 180° C.). Therefore, RFeB system sintered magnets which have a high level of coercivity that can suppress the decrease in magnetization (magnetic force) due to an increase in the temperature have been in demand.

In general, reducing the size of the grains which form the main phase within a sintered magnet increases its coercivity. However, if the particle size of the alloy powder used for the production of the sintered magnet is reduced for that purpose, the alloy powder becomes more easily oxidized, which leads to a decrease in the coercivity.

In recent years, a method has been increasingly used in which a sintered magnet having a shape that is nearly the same as that of a cavity (“near-net shape”) is produced by performing the orienting and sintering process without applying pressure to the alloy powder in the cavity (Patent Literature 1). In the present application, such a method for producing a sintered magnet without performing the compression-molding process is called the “PLP (press-less process) method.” Compared to the pressing method, the PLP method facilitates the handling in an oxygen-free atmosphere (a vacuum or an inert-gas atmosphere) since it does not require the use of a pressing machine. Therefore, the PLP method is advantageous over the pressing method in that an alloy powder having a small particle size can be used in an oxygen-free atmosphere with almost no oxidization, so that a sintered magnet having a high level of coercivity can be obtained.

### CITATION LIST

### Patent literature

Patent Literature 1: WO 2006/004014 A

### SUMMARY OF INVENTION

### Technical Problem

Thus, the PLP method allows the use of an alloy powder with a smaller particle size than the pressing method. However, an observation of the inner structure of the thereby produced sintered magnet with an optical microscope or similar device will reveal that the average grain size of the main phase grains is larger than the average particle size of the used alloy powder. This is most likely due to the fusion (growth) of the particles of the alloy powder into larger sizes during the sintering process. If such a growth of the particles can be suppressed, the coercivity and squareness of the sintered magnet will be further enhanced. It is also expected that the grains in the sintered body will be more compacted and consequently make the sintered body stronger.

The problem to be solved by the present invention is to provide a sintered magnet production method capable of suppressing the growth of the particles of the alloy powder during the sintering process and thereby enhancing the coercivity and squareness as well as increasing the density of the sintered body.

### Solution to Problem

The sintered magnet production method according to the present invention developed for solving the previously described problem is a sintered magnet production method including a filling process in which the cavity of a container is filled with an alloy powder of a raw material for a sintered magnet, an orienting process in which the alloy powder in the cavity is oriented by applying an magnetic field to the alloy powder without applying a mechanical pressure, and a sintering process in which the alloy powder oriented by the orienting process is sintered by heating the alloy powder without applying a mechanical pressure, wherein:

the median D₅₀ of a particle size distribution of the alloy powder measured by a laser diffraction method is 3 μm or less, and a powder of a high-melting-point material having a higher melting point than the heating temperature in the sintering process is mixed in the alloy powder before or in the filling process, where the median D₅₀ of the powder of the high-melting-point material is 0.3 μm or less.

The heating temperature in the sintering process (which is hereinafter called the “sintering temperature”) is normally around 1000° C. For such a temperature, for example, the following compounds can be used as the high-melting-point material: Al₂O₃ (melting point, 2072° C.), MgO (2852° C.), CeO₂ (1950° C.), αFe₂O₃ (1566° C.), SiO₂ (1650° C.), ZrO₂ (2715° C.), Mn₂O₃ (1080° C.), Mn₃O₄ (1564° C.), Ta₂O₅ (1468° C.), Nb₂O₅ (1520° C.) and other oxides, as well as TaC (3880° C.), NbC (3500° C.) and other carbides. The powder may consist of a single kind of high-melting-point material or a mixture of powders of two or more kinds of high-melting-point materials.

In the sintered magnet production method according to the present invention, a powder of a high-melting-point material having a melting point equal to or higher than the sintering temperature (which is hereinafter called the “high-melting material powder”) is mixed in the alloy powder as a pretreatment for the PLP method. Since the average particle size (D₅₀) of the high-melting material powder is sufficiently smaller than that of the alloy powder, the powder can enter the spaces between the particles of the alloy powder. The high-melting material powder retains its solid form even when they are heated during the sintering process, preventing the fusion of the particles of the alloy powder. This most likely suppresses the growth of the particles of the alloy powder during the sintering process and thereby reduces the grain size of the main phase grains within the sintered magnet. Therefore, a sintered magnet with a higher coercivity, squareness and sintered-body density can be produced than in the case of the conventional PLP method.

Furthermore, in the sintered magnet production method according to the present invention, the entry of the particles of the high-melting material powder into the spaces between the particles of the alloy powder can almost certainly prevent the formation of pores or voids and thereby hinder an occurrence and development of cracks starting from such pores or voids.

The high-melting material powder should preferably be mixed so that there are on average 10-1000 particles of the high-melting material powder per one particle of the alloy powder. Using fewer particles makes it difficult to obtain the effect of preventing the fusion of the particles of the alloy powder, while using more particles hinders movement of the particles of the alloy powder and impedes the orientation of these particles during the orienting process, which consequently deteriorates various magnetic properties.

### Advantageous Effects of the Invention

In the sintered magnet production method according to the present invention, the PLP method is performed after the high-melting material powder is mixed in the alloy powder. This most likely prevents the fusion of the particles of the alloy powder during the sintering process and thereby suppresses the growth of those particles. Therefore, a sintered magnet with a higher coercivity, squareness and sintered-body density can be produced than in the case of the conventional PLP method.

### BRIEF DESCRIPTION OF DRAWINGS

FIG. 1 is a table showing magnetic properties of sintered magnets produced by a sintered magnet production method according to one example of the present invention and those produced as a comparative example (Experiment 1).

FIGS. 2A-2C are graphs showing magnetic properties of sintered magnets produced by a sintered magnet production method of the present example and those produced as a comparative example (Experiment 1).

FIG. 3 is a table showing magnetic properties of sintered magnets produced by a sintered magnet production method according to one example of the present invention and those produced as a comparative example (Experiment 2).

FIGS. 4A-4C are graphs showing magnetic properties of sintered magnets produced by a sintered magnet production method of the present example and those produced as a comparative example (Experiment 2).

FIGS. 5A and 5B are graphs showing relationships between the aging temperature and magnetic properties of sintered magnets produced by a sintered magnet production method of the present example and those produced as a comparative example (Experiment 2).

FIG. 6 is a graph showing a relationship between the MP value and the density Ds of sintered magnets produced by a sintered magnet production method of the present example and those produced as a comparative example (Experiment 2).

FIG. 7 is a table showing magnetic properties of sintered magnets produced by a sintered magnet production method according to one example of the present invention and those produced as a comparative example (Experiment 4).

FIGS. 8A-8C are graphs showing magnetic properties of sintered magnets produced by a sintered magnet production method of the present example and those produced as a comparative example (Experiment 4).

FIG. 9 is a table showing magnetic properties of sintered magnets produced by a sintered magnet production method according to one example of the present invention and those produced as a comparative example (Experiment 5).

FIGS. 10A-10C are graphs showing magnetic properties of sintered magnets produced by a sintered magnet production method of the present example and those produced as a comparative example (Experiment 5).

FIG. 11 is a graph showing the relationship between the aging temperature and a magnetic property of sintered magnets produced by a sintered magnet production method of the present example and those produced as a comparative example (Experiment 5).

FIG. 12 is a table showing magnetic properties of sintered magnets produced by a sintered magnet production method according to one example of the present invention and those produced as a comparative example (Experiment 6).

FIGS. 13A-13C are graphs showing magnetic properties of the sintered magnets produced by a sintered magnet production method of the present example and those produced as a comparative example (Experiment 6).

### DESCRIPTION OF EMBODIMENTS

Examples of the sintered magnet production method according to the present invention are hereinafter described with reference to the drawings.

### EXAMPLE

The sintered magnet production method of the present example has the following processes: a mixing process in which a powder of a high-melting material having a higher melting point than the heating temperature (“sintering temperature”) in the sintered process (which will be mentioned later) is mixed in a fine powder of a starting alloy for a sintered magnet (“alloy powder”); a filling process in which the cavity of a mold is filled with the mixed powder of the alloy powder and the high-melting material powder; an orienting process in which the mixed powder in the cavity is oriented by applying a magnetic field without applying a mechanical pressure; and a sintering process in which the mixed powder oriented in the cavity is sintered by heating it together with the mold without applying a mechanical pressure. A sintered magnet is produced by performing those processes in the previously mentioned order in an oxygen-free atmosphere.

The average particle size of the high-melting material powder is sufficiently smaller than that of the alloy powder: the average particle size of the alloy powder in terms of the median D₅₀ of the particle size distribution measured by the laser diffraction method is 3 μm or less, while that of the high-melting material powder in terms of D₅₀ is 0.3 μm or less (hereinafter, the “average particle size” always represents the median D₅₀ of the particle size distribution measured by the laser diffraction method).

This high-melting material powder is heated to approximately 400° C. in vacuum to dehydrate it.

Subsequently, a predetermined amount of high-melting material powder is mixed in the alloy powder, and the mixture is kneaded after a lubricant is added to it. As a result, the particles of the high-melting material powder adhere to the surface of the particles of the alloy powder. The lubricant will help the alloy powder smoothly move in the filling and orienting processes.

The amount of high-melting material powder to be mixed is determined according to the number of particles of the high-melting material powder to be adhered per one particle of the alloy powder, on the assumption that all particles of the high-melting material powder will be adhered to those of the alloy powder. For example, consider the case where an Al₂O₃ powder (high-melting material powder, whose specific gravity is approximately 3.98) having an average particle size of 0.05 μm is mixed in a Nd₂F₁₄B powder (alloy powder, whose specific gravity is approximately 7.5) having an average particle size of 2 μm. The volume ratio per particle of these powders is 2³:0.05³=64000:1, and the weight ratio is 64000×7.5:1×3.98=1:0.000008291. Given the aforementioned average particle sizes, if on average 100 particles of the Al₂O₃ powder need to be adhered per one particle of the Nd₂F₁₄B powder, the amount of Al₂O₃ powder to be mixed is 0.08291 wt % of the Nd₂F₁₄B powder.

Considering another example, if an Al₂O₃ powder with an average particle size of 0.05 μm is to be mixed in a Nd₂F₁₄B powder with an average particle size of 3 μm, the volume ratio per particle of these powders is 3³:0.05³=216000:1, and the weight ratio is 216000×7.5:1×3.98=1:0.000002456. Given the aforementioned average particle sizes, if on average 100 particles of the Al₂O₃ powder need to be adhered per one particle of the Nd₂F₁₄B powder, the amount of Al₂O₃ powder to be mixed is 0.02456 wt % of the Nd₂F₁₄B powder.

The average number of particles of the high-melting material powder to be adhered per one particle of the alloy powder is hereinafter called the “MP value” (which is 100 in both of the previous examples).

### Experiment 1

An alloy powder with an average particle size of 2 μm (this value, as well as the particle sizes to be mentioned later were measured with a laser diffraction type particle size distribution measurement system, HELOS&RODOS, manufactured by Sympatec GmbH) was prepared from a starting alloy having a composition shown in Table 1 below (the unit of the values is wt %), and an Al₂O₃ powder (high-melting point material powder) with an average particle size of 0.05 μm was mixed in the alloy powder at an MP value of 200 or 400. After methyl laurate (lubricant) was added by 0.105 wt % of the mixed powder and the mixture was stirred in a beaker, the mixture was kneaded by pouring it into a rotary crusher “Wonder Blender” (Osaka Chemical Co., Ltd.) two times, in ten seconds each time (mixing process).

TABLE 1

| Nd | Pr | Dy | Tb | Ni | Al | Cu | B | Mn | Cr | Co | Fe |
|---|---|---|---|---|---|---|---|---|---|---|---|
| 26.4 | 4.18 | 0.01 | 0 | 0 | 0.27 | 0.11 | 0.95 | 0 | 0 | 0.94 | bal. |

This mixed powder was placed in the cavity of a mold at a filling density of 3.2 g/cm³ (filling process) and oriented in this state by a magnetic field with a maximum strength of 5.4 T (orienting process). After the mixed powder oriented in this manner was placed in a sintering furnace together with the mold, the temperature within the furnace was increased to 950-963° C. (this temperature is called the “sintering temperature”, which differs depending on the sample) in 8 hours and further maintained at that temperature for 4 hours to sinter the alloy powder (sintering process). Subsequently, the powder was heated at 800° C. for 0.5 hours (the first-stage aging treatment) and then rapidly cooled, after which it was further heated at 490-540° C. for 1.5 hours (the second-stage aging treatment) and then rapidly cooled. In the sintering process, argon gas (inert gas) was passed through the sintering furnace at a flow rate of 2 L per minute (this operation of supplying argon gas during the sintering process is hereinafter called the “argon-gas supply”) until the temperature in the sintering furnace reached 425° C., after which the furnace was evacuated to 1×10⁻⁴ Pa or lower. The obtained sintered body was machined into a sintered magnet of 3 mm in thickness with 7-mm-square pole faces.

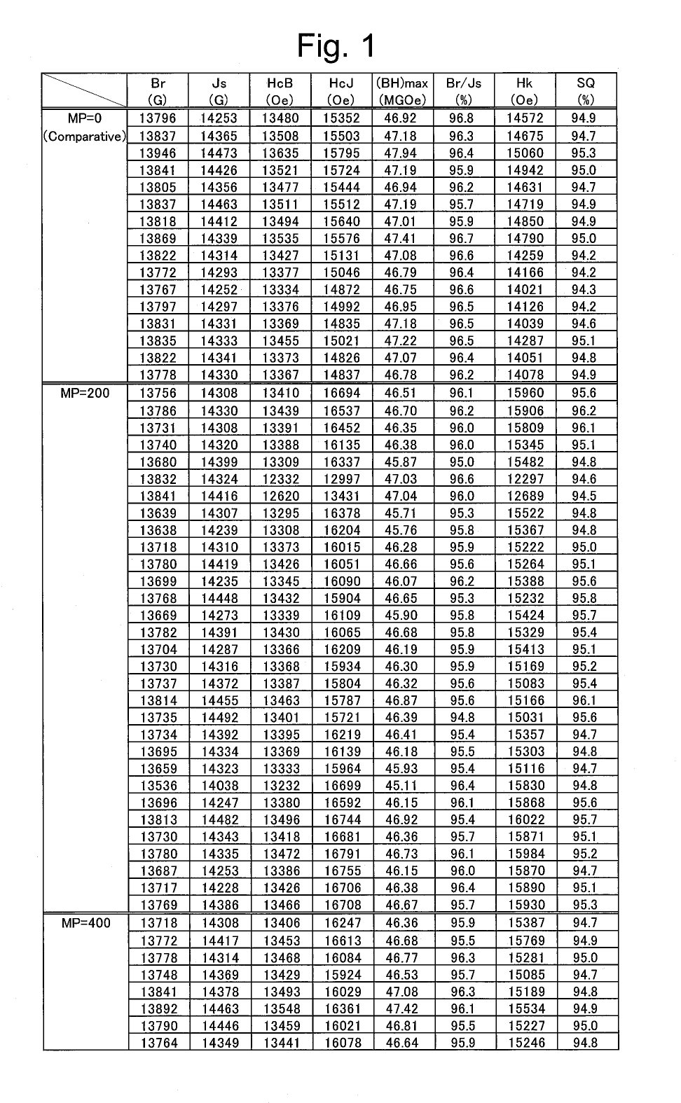

The magnetic properties of the obtained sintered magnets are shown in the table of FIG. 1. In this table, the data with an MP value of zero show the properties of sintered magnets produced by a conventional PLP method in which the same producing conditions as previously described were applied except that no high-melting material powder was added (“comparative example”). In this table, Br is the residual magnetic flux density (the magnitude of the magnetic flux density B observed when the magnetic field H is zero), Js is the saturation magnetization (the maximum value of magnetization J), HcB is the coercivity defined by the demagnetization curve (B-H curve), HcJ is the coercivity defined by the magnetization curve (J-H curve), (BH)max is the maximum energy product (the maximum value of the product of the magnetic flux density B and the magnetic field H on the demagnetization curve), Br/Js is the degree of orientation, and Hk is the absolute value of the magnetic field observed when the magnetization is 10% lower than the remanent magnetization Jr (the magnetization observed when the magnetic field H is zero). SQ is the squareness ratio (an index representing the squareness), which equals Hk divided by HcJ. Greater values of those properties mean better magnet properties are obtained. A greater coercivity HcJ means a higher effect of impeding the decrease in the magnetization due to an increase in the temperature. The sintered magnet production method of the present example is primarily aimed at increasing the coercivity HcJ.

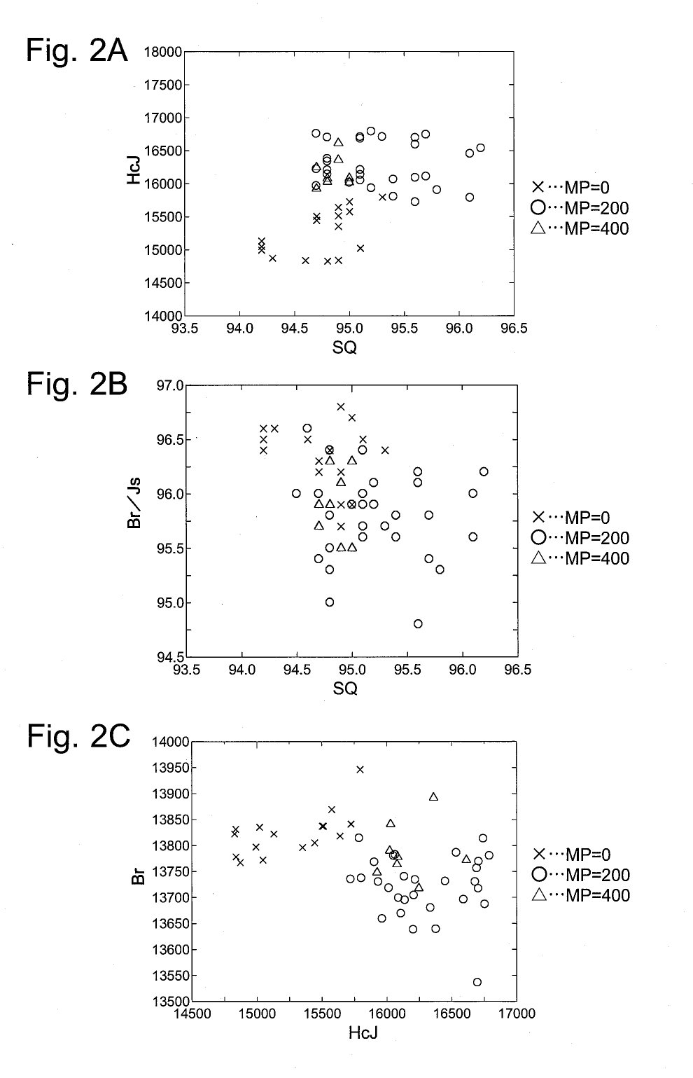

FIGS. 2A-2C graphically illustrate the results shown in the table of FIG. 1. FIG. 2A is a graph showing the relationship between the squareness ratio SQ and the coercivity HcJ of each sintered magnet in FIG. 1, FIG. 2B is a graph showing the relationship between the squareness ratio SQ and the degree of orientation Br/Js, and FIG. 2C is a graph showing the relationship between the coercivity HcJ and the residual magnetic flux density Br.

The graph of FIG. 2A shows that, in any of the cases with the MP values of 200 and 400, the obtained sintered magnets had higher levels of coercivity HcJ than the comparative example. The result also demonstrates that the squareness ratios SQ for the MP value of 400 were approximately equal to the comparative example, while those for the MP value of 200 were equal to or even higher than the comparative example.

As for the degree of orientation Br/Js and the residual magnetic flux density Br, as can be seen in FIGS. 2B and 2C, the present examples (both of the MP values of 200 and 400) generally tend to have lower values than the comparative example. Such a relative tendency is not specific to the case of the present and comparative examples, but can be generally observed in any sintered magnets. Nevertheless, some of the sintered magnets of the present example had higher levels of coercivity HcJ than the comparative example while being approximately equal to the comparative example in terms of the degree of orientation Br/Js and the residual magnetic flux density Br.

### Experiment 2

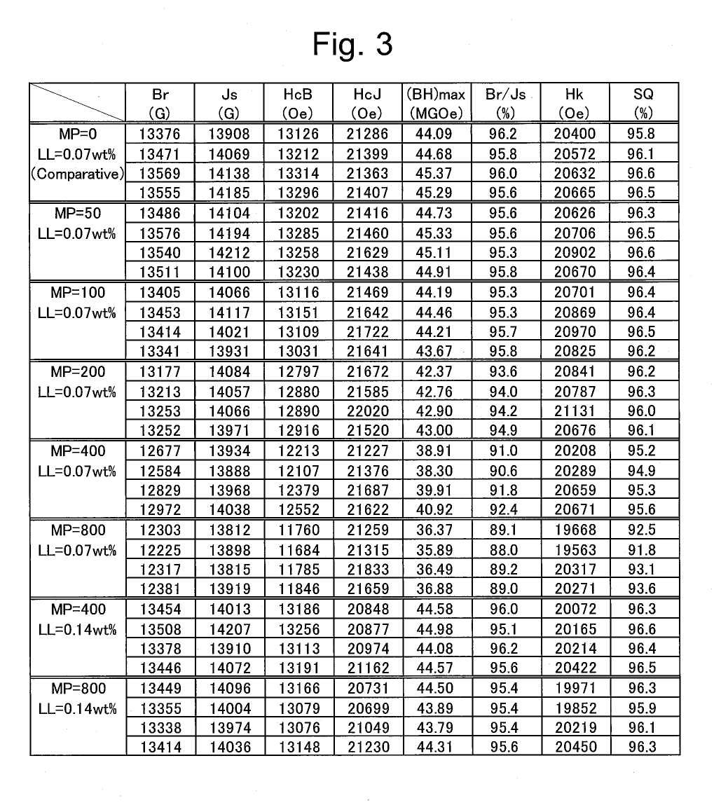

An experiment was performed using an alloy powder of a starting alloy having a composition shown in Table 2 below, under the following conditions: the average particle size of the alloy powder was 2.96 μm; the average particle size of the high-melting material powder (Al₂O₃ powder) was 0.05 μm; the MP value was one of the following values: 50, 100, 200, 400 and 800; the additive amount LL of methyl laurate was either 0.07 wt % or 0.14 wt %; the filling density Df of the mixed powder in the mold cavity was 3.3 g/cm³; the orienting magnetic field was 5.4 T; the sintering temperature was 995° C. (the temperature was increased to this level in 13 hours 25 minutes and subsequently maintained at this level for 4 hours, with the argon-gas supply performed at 2 L/min until 400° C.); the first-stage aging treatment was performed at 800° C. for 0.5 hours; and the second-stage aging treatment was performed at 530-560° C. for 1.5 hours. The result is shown in the table of FIG. 3. A result obtained with an MP value of zero is also shown in the same table as a comparative example.

TABLE 2

| Nd | Pr | Dy | Tb | Ni | Al | Cu | B | Mn | Cr | Co | Fe |
|---|---|---|---|---|---|---|---|---|---|---|---|
| 23.0 | 4.92 | 2.46 | 0.05 | 0.01 | 0.20 | 0.13 | 0.95 | 0.05 | 0.02 | 0.01 | bal. |

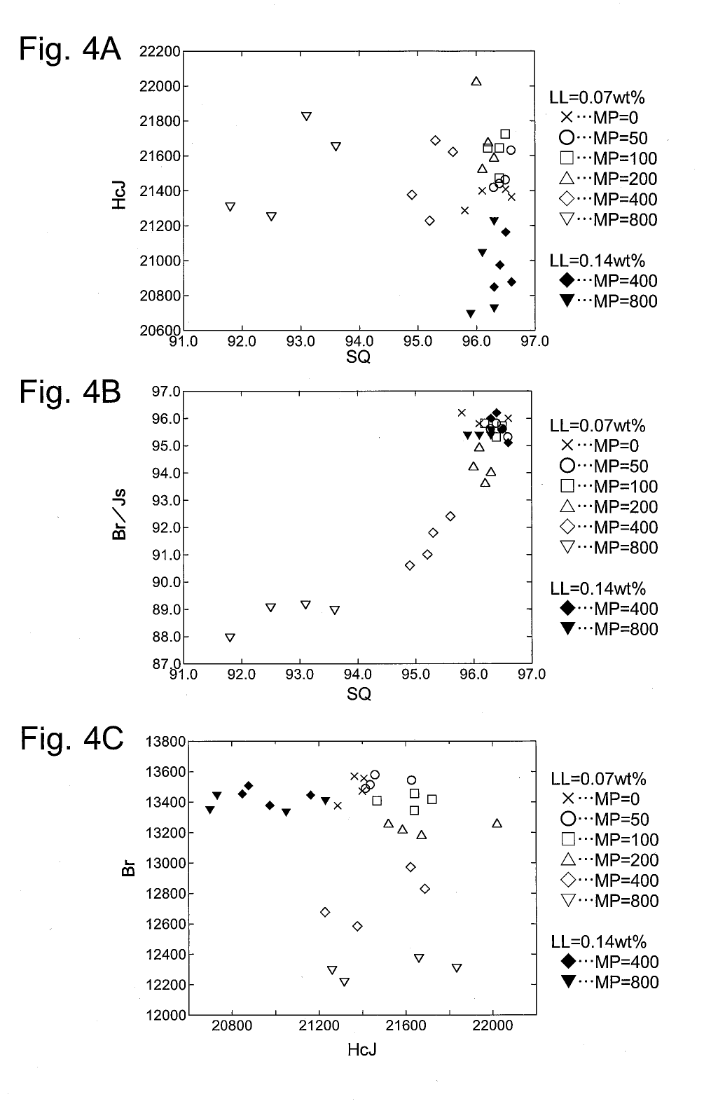

FIGS. 4A-4C graphically illustrate the result shown in the table of FIG. 3. FIG. 4A is a graph showing the relationship between the squareness ratio SQ and the coercivity HcJ of each sintered magnet in FIG. 3, FIG. 4B is a graph showing the relationship between the squareness ratio SQ and the degree of orientation Br/Js, and FIG. 4C is a graph showing the relationship between the coercivity HcJ and the residual magnetic flux density Br.

The graph of FIG. 4A shows that the sintered magnet having the highest coercivity HcJ was obtained when the MP value was 200. Sintered magnets having higher levels of coercivity HcJ than the comparative example with almost equal squareness ratios SQ were obtained when the MP value was 50, 100 and 200. As for the sintered magnets with MP values of 400 and 800, when the additive amount LL of methyl laurate was the same as the comparative example, 0.07 wt %, the coercivity HcJ on the whole tends to be higher than in the comparative example, although less noticeable than in the case of the MP values of 50, 100 and 200. These sintered magnets also tended to have lower values of the degree of orientation Br/Js and the residual magnetic flux density Br, as can be seen in FIGS. 4B and 4C.

The reason for the comparatively low magnetic properties of the samples with high MP values is that the degree of orientation was decreased since an excessive amount of particles of the high-melting material powder were adhered to the surface of the particles of the alloy powder and hindered the movement of these particles. This problem can be solved by increasing the additive amount of lubricant (methyl laurate) to reduce the friction caused by the particles of the high-melting material powder.

The sintered magnets for which the additive amount LL of methyl laurate was increased to 0.14 wt % had greater values of the squareness ratio SQ, degree of orientation Br/Js and residual magnetic flux density Br, although their coercivity HcJ was decreased. This decrease in the coercivity HcJ is due to the methyl laurate which became an impurity and remained in the sintered magnets. Thus, there are trade-offs between the coercivity HcJ and the three other magnetic properties (the squareness ratio SQ, degree of orientation Br/Js, and residual magnetic flux density Br). Therefore, the additive amount of lubricant should be appropriately controlled according to the use of the sintered magnet.

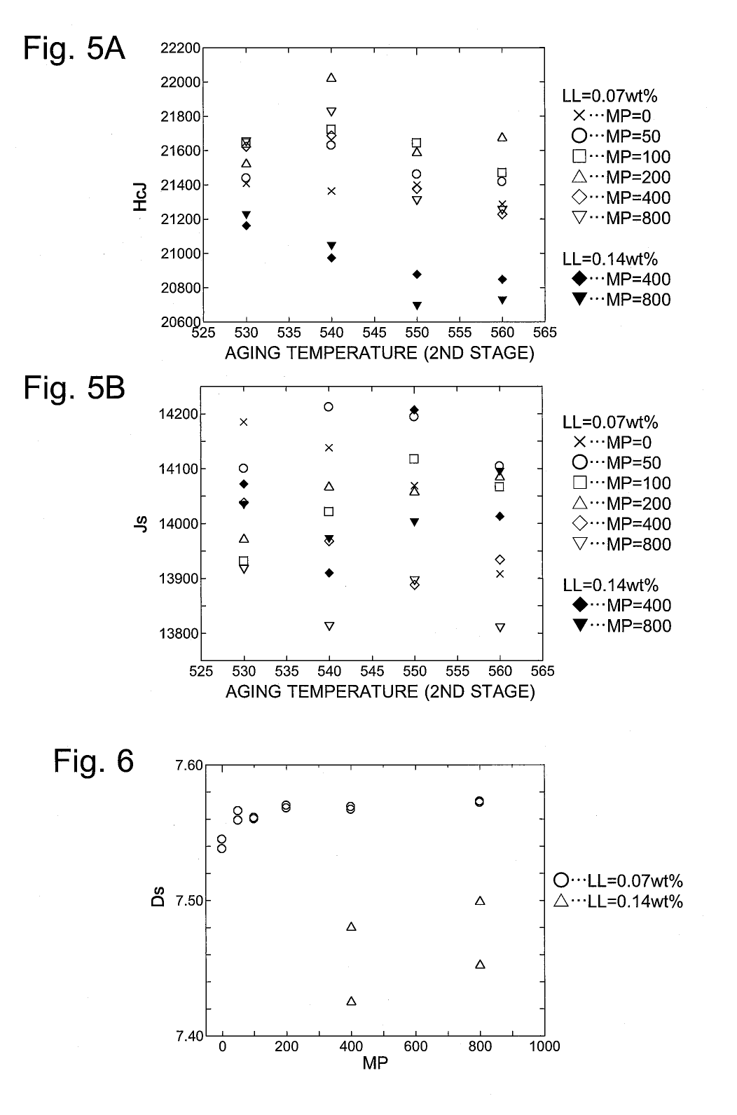

FIG. 5A is a graph showing the relationship between the temperature for the aging treatment (which is hereinafter called the “aging temperature”) in the second stage and the coercivity HcJ, while FIG. 5B is a graph showing the relationship between the aging temperature in the second stage and the saturation magnetization Js. As can be seen in FIG. 5A, when the additive amount of methyl laurate was 0.07 wt %, the coercivity HcJ under the same producing conditions improved with the increasing MP value until this value reached 200. As for the saturation magnetization Js, the sintered magnets with the MP value of zero tend to have higher values than those with the MP values of 50-800 under the same producing conditions. However, at high aging temperatures, the sintered magnets with the MP values of 50-800 had higher Js values than those of the comparative example.

FIG. 6 is a graph showing the density Ds of the sintered magnets (sintered-body density) for each MP value. This graph shows that mixing the Al₂O₃ powder increases the density Ds of the sintered magnet. This is partly because the Al₂O₃ powder suppresses the growth of the particles of the alloy powder during the sintering process and thereby reduces the grain size of the main phase grains within the sintered magnet, making the internal structure denser, and also because the Al₂O₃ powder enters the pores or voids formed within the sintered magnet and fills them. The filling of such pores and voids with the Al₂O₃ powder lowers the probability of an occurrence and development of cracks starting from those pores or voids due to an impact, temperature fluctuation or other factors. When LL=0.14 wt %, the density Ds of the sintered magnets was lower than when LL=0.07 wt %. This is partly because the increase in the additive amount of lubricant caused an increase in the optimum sintering temperature, and also because a considerable amount of carbon remained during the sintering process of the alloy powder, and this increase in the amount of residual carbon hindered the sintering.

### Experiment 3

Using an alloy powder of a starting alloy having the aforementioned composition shown in Table 2, three sintered magnets with different high-melting material powders were produced under the following conditions: the average particle size of the alloy powder was 3 μm; the average particle size of the high-melting material powder (made of Al₂O₃, CeO₂ or MgO) was 0.3 μm; the MP value was 200; the additive amount LL of methyl laurate was 0.07 wt %; the filling density Df of the mixed powder in the mold cavity was 3.3 g/cm³; the orienting magnetic field was an AC field (two times) and a DC field (one time), with a strength of 5.4 T each time; the sintering temperature was 995° C. (the temperature was increased to this level in 8 hours and subsequently maintained at this level for 4 hours, with the argon-gas supply performed at 2 L/min until 425° C.); the aging treatment was performed at 800° C. for 0.5 hours and 560° C. for 1.5 hours. As a comparative example, another sintered magnet was produced under the same conditions except that no high-melting material powder was mixed (i.e. with the MP value of zero). The densities of the obtained sintered magnets were 7.527 g/cm³ in the case of comparative example, 7.542 g/cm³ in the case where the Al₂O₃ powder was used, 7.543 g/cm³ in the case where the CeO₂ powder was used, and 7.552 g/cm³ in the case where the MgO powder was used. Thus, the sintered magnets produced using the high-melting material powders other than the Al₂O₃ powder also had higher densities than the comparative example.

### Experiment 4

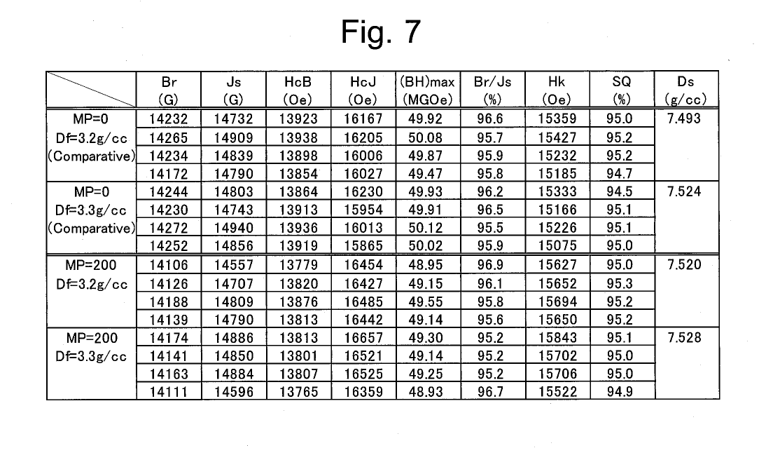

An experiment was performed using an alloy powder of a starting alloy having a composition shown in Table 3 below, under the following conditions: the average particle size of the alloy powder was 3 μm; the average particle size of the high-melting material powder (Al₂O₃ powder) was 0.05 μm; the MP value was 200; the additive amount LL of methyl laurate was 0.09 wt %; the filling density Df of the mixed powder in the mold cavity was 3.2 g/cm³ or 3.3 g/cm³; the orienting magnetic field was an AC field of 5.4 T; the sintering temperature was 995° C. (the temperature was increased to this level in 12 hours and subsequently maintained at this level for 4 hours, with the argon-gas supply performed at 2 L/min until 500° C.); the first-stage aging treatment was performed at 800° C. for 0.5 hours; and the second-stage aging treatment was performed at 520° C. for 1.5 hours. The result is shown in the table of FIG. 7. A result obtained with an MP value of zero and the additive amount of methyl laurate set at 0.079 wt % is also shown in the table of FIG. 7 as a comparative example.

TABLE 3

| Nd | Pr | Dy | Tb | Ni | Al | Cu | B | Mn | Cr | Co | Fe |
|---|---|---|---|---|---|---|---|---|---|---|---|
| 30.6 | 4.18 | 0 | 0 | 0 | 0.27 | 0.11 | 0.95 | 0 | 0 | 0.94 | bal. |

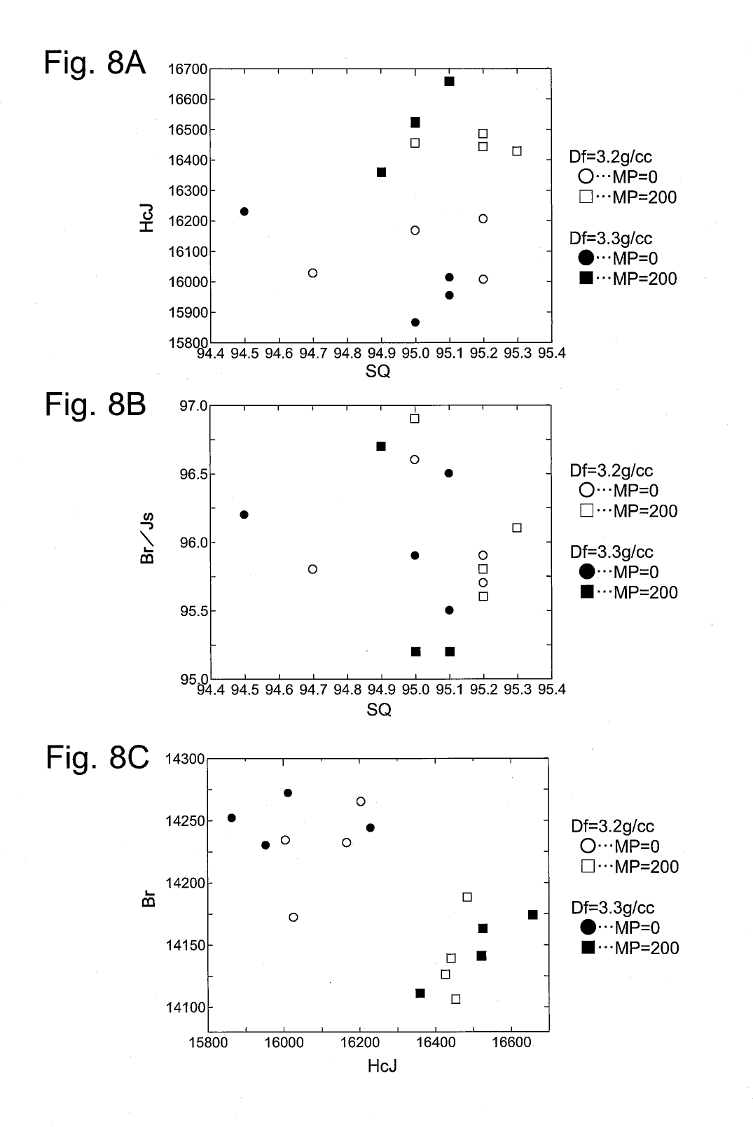

FIGS. 8A-8C graphically illustrate the result shown in the table of FIG. 7. FIG. 8A is a graph showing the relationship between the squareness ratio SQ and the coercivity HcJ of each sintered magnet in FIG. 7, FIG. 8B is a graph showing the relationship between the squareness ratio SQ and the degree of orientation Br/Js, and FIG. 8C is a graph showing the relationship between the coercivity HcJ and the residual magnetic flux density Br.

As can be seen in FIG. 8A, the sintered magnets with the MP value of 200 had higher levels of coercivity HcJ than the sintered magnets with the MP value of zero, despite the fact that the additive amount LL of methyl laurate in the case of the MP value of 200 was higher than in the case of the MP value of zero. As for the squareness ratio SQ and the degree of orientation Br/Js, the sintered magnets with the MP value of 200 were almost equal to or even higher than those with the MP value of zero. Thus, by appropriately controlling the MP value and the additive amount of methyl laurate, it is possible to improve the coercivity HcJ, squareness SQ and degree of orientation Br/Js to higher levels than those of the sintered magnets produced by the conventional PLP method. As for the residual magnetic flux density Br, some of the sintered magnets with the MP value of 200 had lower values than the sintered magnets with the MP value of zero. As already explained, this is a tendency that can be generally observed in any sintered magnets.

### Experiment 5

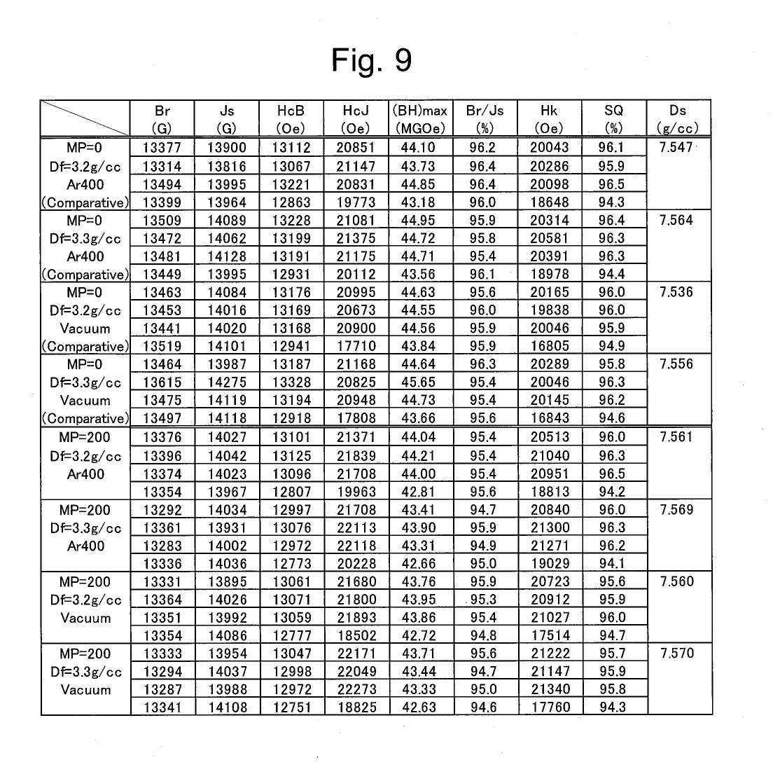

An experiment was performed using an alloy powder of a starting alloy having the aforementioned composition shown in Table 2, under the following conditions: the average particle size of the alloy powder was 3 μm; the average particle size of the high-melting material powder (Al₂O₃ powder) was 0.05 μm; the MP value was 200; the additive amount LL of methyl laurate was 0.07 wt %; the filling density Df of the mixed powder in the mold cavity was 3.2 g/cm³ or 3.3 g/cm³; the orienting magnetic field was an AC field (two times) and a DC field (one time), with a strength of 5.4 T each time; the sintering temperature was 1005° C. (the temperature was increased to this level in 13 hours 25 minutes and subsequently maintained at this level for 4 hours); the first-stage aging treatment was performed at 800° C. for 0.5 hours; and the second-stage aging treatment was performed at 520° C. for 1.5 hours, or both the first and second stages of the aging treatment were omitted. The result is shown in the table of FIG. 9. In the table, “Ar400” means that the argon-gas supply was performed until the temperature in the sintering furnace reached 400° C., while “Vacuum” means that the argon-gas supply was not performed but the inside of the sintering furnace was maintained in a vacuum state throughout the entire process including the temperature-increasing phase. A result obtained with an MP value of zero is also shown in the table of FIG. 9 as a comparative example.

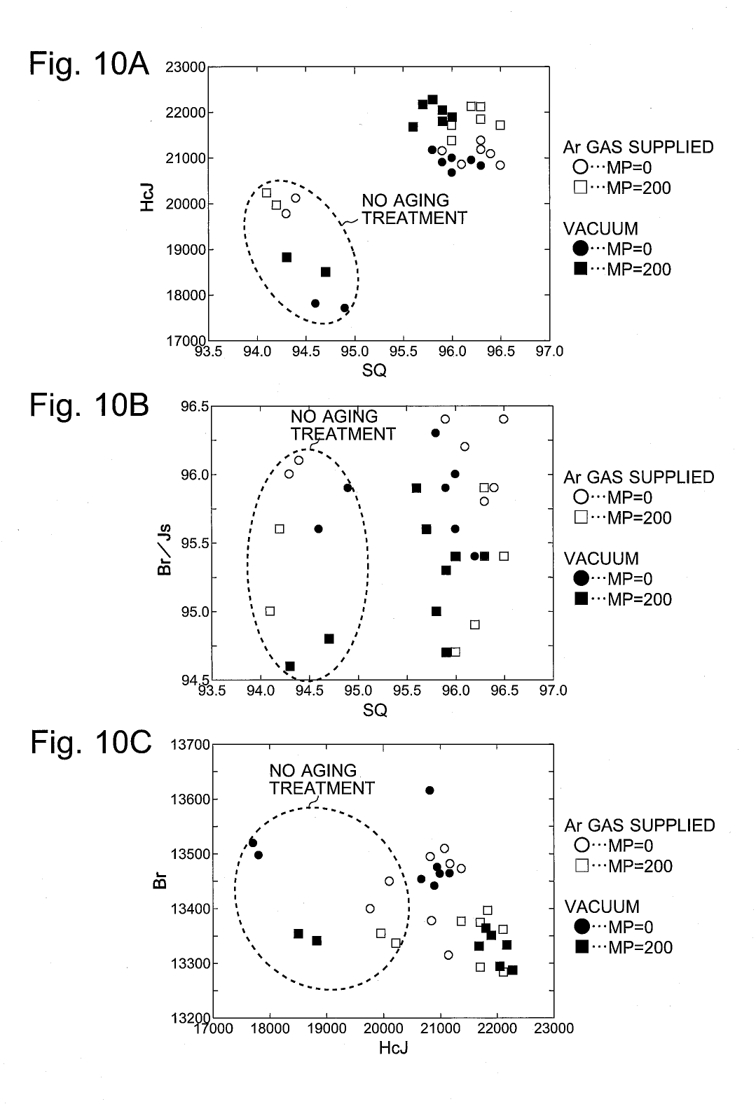

FIGS. 10A-10C graphically illustrate the result shown in the table of FIG. 9. FIG. 10A is a graph showing the relationship between the squareness ratio SQ and the coercivity HcJ of each sintered magnet in FIG. 9, FIG. 10B is a graph showing the relationship between the squareness ratio SQ and the degree of orientation Br/Js, and FIG. 10C is a graph showing the relationship between the coercivity HcJ and the residual magnetic flux density Br. The data surrounded by the broken lines are those obtained without performing the aging treatment.

As can be seen in FIG. 10A, both the coercivity HcJ and squareness ratio SQ of the sintered magnets produced without the aging treatment become lower than those of the sintered magnets which underwent the aging treatment. As for the degree of orientation Br/Js and the residual magnetic flux density Br, as can be seen in FIGS. 10B and 10C, the sintered magnets produced without the aging treatment were almost comparable to the sintered magnets which underwent the aging treatment.

The results shown in FIGS. 10A-10C also show that the sintered magnets of the “Ar Gas Supplied” group were almost equal to the sintered magnets of the “Vacuum” group in terms of the coercivity HcJ, degree of orientation Br/Js and residual magnetic flux density Br, while their squareness ratios SQ showed a general tendency to be higher than those of the sintered magnets of the “Vacuum” group.

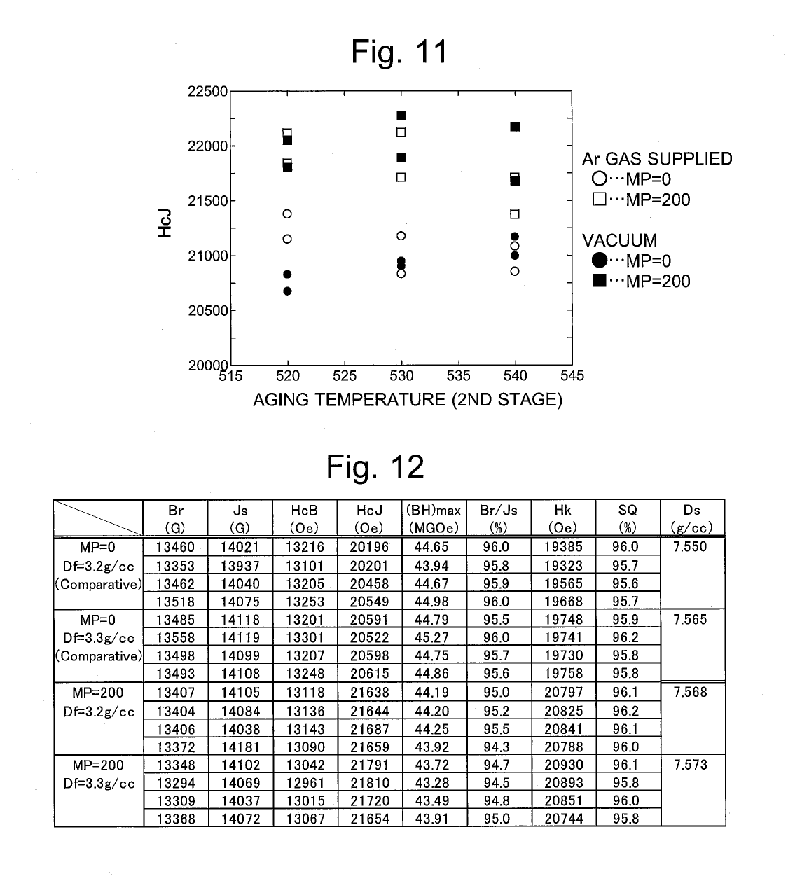

FIG. 11 is a graph showing the relationship between the aging temperature in the second stage and the coercivity HcJ of the sintered magnets which underwent the aging treatment. As can be seen, the sintered magnets with the MP value of 200 had higher levels of coercivity HcJ than the comparative example at any aging temperature.

### Experiment 6

An experiment was performed using an alloy powder of a starting alloy having the aforementioned composition shown in Table 2, under the following conditions: the average particle size of the alloy powder was 3 μm; the average particle size of the high-melting material powder (Al₂O₃ powder) was 0.05 μm; the MP value was 200; the additive amount LL of methyl laurate was 0.07 wt %; the filling density Df of the mixed powder in the mold cavity was 3.2 g/cm³ or 3.3 g/cm³; the orienting magnetic field was an AC field (two times) and a DC field (one time), with a strength of 5.4 T each time; the sintering temperature was 1020° C. (the temperature was increased to this level in 12 hours and subsequently maintained at this level for 4 hours, with the inside of the sintering furnace constantly in vacuum); the first-stage aging treatment was performed at 800° C. for 0.5 hours; and the second-stage aging treatment was performed at 530° C. for 1.5 hours. The result is shown in the table of FIG. 12. A result obtained with an MP value of zero is also shown in the table of FIG. 12 as a comparative example.

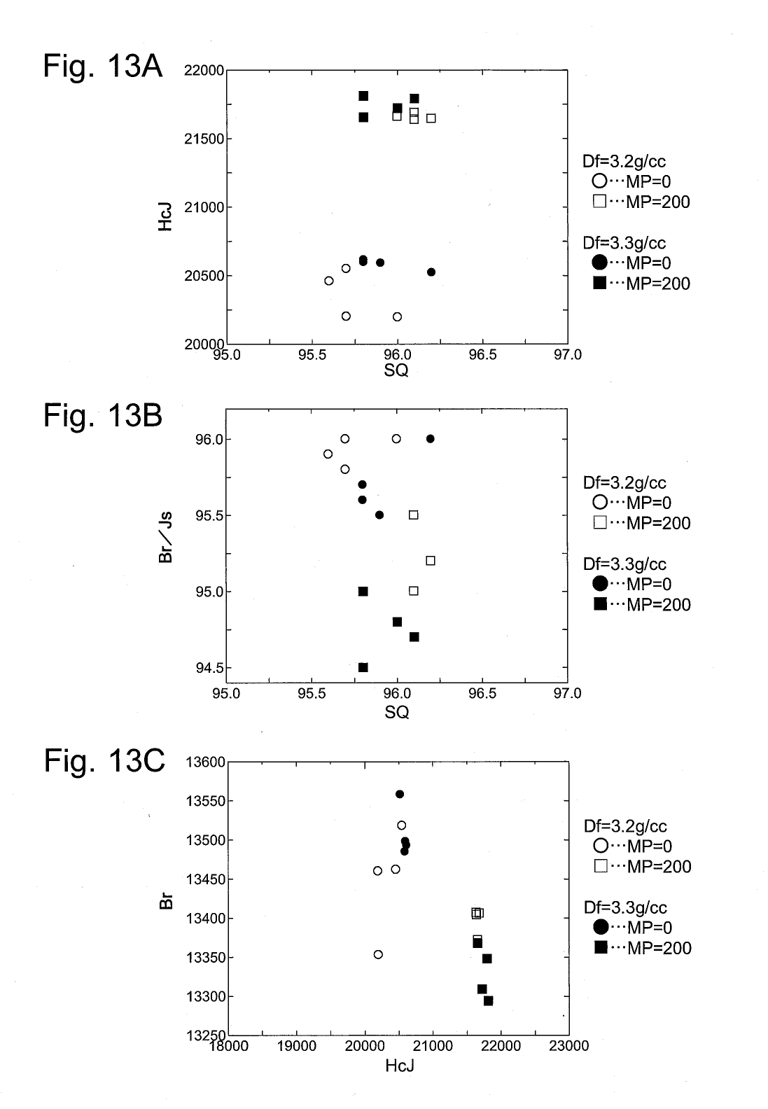

FIGS. 13A-13C graphically illustrate the result shown in the table of FIG. 12. FIG. 13A is a graph showing the relationship between the squareness ratio SQ and the coercivity HcJ of each sintered magnet in FIG. 12, FIG. 13B is a graph showing the relationship between the squareness ratio SQ and the degree of orientation Br/Js, and FIG. 13C is a graph showing the relationship between the coercivity HcJ and the residual magnetic flux density Br.

As can be seen in the graph of FIG. 13A, the sintered magnets with the MP value of 200 had higher levels of coercivity HcJ than those with the MP value of zero. Their squareness ratios SQ were almost equal. As for the degree of orientation Br/Js and the residual magnetic flux density Br, the sintered magnets with the MP value of 200 tended to have lower values than the comparative example. This is most likely because the additive amount LL of methyl laurate serving as the lubricant was insufficient for the MP value.

1. A sintered magnet production method including a filling process in which a cavity of a container is filled with an alloy powder of a raw material for a sintered magnet, an orienting process in which the alloy powder in the cavity is oriented by applying an magnetic field to the alloy powder without applying a mechanical pressure, and a sintering process in which the alloy powder oriented by the orienting process is sintered by heating the alloy powder without applying a mechanical pressure, wherein:
a median D₅₀ of a particle size distribution of the alloy powder measured by a laser diffraction method is 3 μm or less, and a powder of a high-melting-point material having a higher melting point than a heating temperature in the sintering process is mixed in the alloy powder before or in the filling process, where the median D₅₀ of the powder of the high-melting-point material is 0.3 μm or less.

2. The sintered magnet production method according to claim 1, wherein the powder of the high-melting-point material is a powder of a compound selected from the group of Al₂O₃, MgO, CeO₂, αFe₂O₃, SiO₂, ZrO₂, Mn₂O₃, Mn₃O₄, Ta₂O₅, Nb₂O₅, TaC and NbC, or a mixed powder of two or more of these compounds.

3. The sintered magnet production method according to claim 1, wherein on average 10-1000 particles of the high-melting-point material are mixed per one particle of the alloy powder.

4. The sintered magnet production method according to claim 1, after the powder of the high-melting-point material is mixed in the alloy powder, the obtained mixed is kneaded with an added lubricant.

5. The sintered magnet production method according to claim 2, wherein on average 10-1000 particles of the high-melting-point material are mixed per one particle of the alloy powder.

6. The sintered magnet production method according to claim 2, wherein, after the powder of the high-melting-point material is mixed in the alloy powder, the obtained mixed is kneaded with an added lubricant.

7. The sintered magnet production method according to claim 3, wherein, after the powder of the high-melting-point material is mixed in the alloy powder, the obtained mixed is kneaded with an added lubricant.

8. The sintered magnet production method according to claim 5, wherein, after the powder of the high-melting-point material is mixed in the alloy powder, the obtained mixed is kneaded with an added lubricant.
